(19) United States
(12) Patent Application Publication
(10) Pub. No.: US 2014/0141338 A1
(43) Pub. Date: May 22, 2014

(54) RECHARGEABLE LITHIUM BATTERY

(71) Applicant: SAMSUNG SDI CO., LTD., Yongin-si (KR)

(72) Inventor: Chan-Seok KIM, Yongin-si (KR)

(73) Assignee: SAMSUNG SDI CO., LTD., Yongin-si (KR)

(21) Appl. No.: 13/801,466

(22) Filed: Mar. 13, 2013

(30) Foreign Application Priority Data
Nov. 19, 2012 (KR) 10-2012-0131186

(51) Int. Cl. H01M 10/04

(52) U.S. Cl. CPC H01M 10/0431
USPC 429/246; 156/185

(57) ABSTRACT

Disclosed is a rechargeable lithium battery, including an electrode assembly including a positive electrode, a separator, and a negative electrode; and an electrode tape adhered to an outer surface of the electrode assembly, the electrode tape including a thermosetting resin selected from polyvinylchloride, a mixture of nitrile rubber and phenol resin, epoxy resin, polyurethane, melamine resin, urea resin, or combination thereof.

### CROSS-REFERENCE TO RELATED APPLICATIONS

This application claims priority to and the benefit of Korean Patent Application No. 10-2012-0131186 filed in the Korean Intellectual Property Office on Nov. 19, 2012, the entire contents of which are incorporated herein by reference.

### BACKGROUND

1. Field

This disclosure relates to a lithium rechargeable battery.

2. Description of the Related Technology

Rechargeable lithium batteries have recently drawn attention as a power source for small portable electronic devices. They use an organic electrolyte and thereby have twice or more discharge voltage than that of a conventional battery using an alkali aqueous solution and accordingly, have high energy density. For a positive active material of rechargeable lithium batteries, an oxide including lithium and transition elements and being capable of intercalating and deintercalating lithium ions, and for example, LiCoO₂, LiMn₂O₄, LiNi₁₋ₓCoₓO₂ (0<x<1), and the like, has been used.

As for negative active materials of a rechargeable lithium battery, various carbon-based materials such as artificial graphite, natural graphite, and hard carbon, which can intercalate and deintercalate lithium ions, have been used. The rechargeable lithium battery can include a jelly-roll type of electrode assembly formed by spirally winding a positive electrode, a negative electrode, and a separator between the positive electrode and the negative electrode, a battery case in which the electrode assembly is included, and an electrolyte injected into the battery case, thereby immersing the electrode assembly.

For positioning the jelly-roll type of electrode assembly in the battery case, an outer surface of the electrode assembly is covered with a finish tape and compressed after spirally winding the electrode assembly.

### SUMMARY

An example embodiment provides a rechargeable lithium battery exhibiting good safety.

According to an embodiment, a rechargeable lithium battery including an electrode assembly including a positive electrode, a separator, and a negative electrode; and an electrode tape attached to an outer surface of the electrode assembly, is provided.

The electrode tape includes a thermosetting resin. In one embodiment, the thermosetting resin may be selected from polyvinyl chloride, a mixture of nitrile rubber and phenol resin, epoxy resin, polyurethane, melamine resin, urea resin, or a combination thereof. In another embodiment, the thermosetting resin may be a mixture of nitrile rubber and phenol resin, and epoxy resin, polyurethane, and a combination thereof. The electrode tape may further include an adhesive layer positioned on one surface to contact the electrode assembly.

The electrode tape may further a metal. In one embodiment, the electrode tape includes a metal substrate and a thermosetting resin layer surrounding the metal substrate. The metal may be aluminum.

The thickness of the thermosetting resin layer may be about 10 μm to about 2000 μm, and the thickness of the metal substrate may be about 1 μm to about 1000 μm.

Hereinafter, further embodiments of this disclosure will be described in detail.

The electrode tape including the thermosetting resin in the rechargeable lithium battery according to one embodiment may improve the hardness and the strength of the battery, thereby exhibiting good safety.

### BRIEF DESCRIPTION OF THE DRAWINGS

FIG. 1 is a drawing showing the structure of the electrode tape according to one embodiment.

FIG. 2 is a schematic view showing a rechargeable lithium battery according to one embodiment.

### DETAILED DESCRIPTION

Example embodiments of the present disclosure will hereinafter be described in detail. However, these embodiments are only examples, and this disclosure is not limited thereto.

One embodiment provides a rechargeable lithium battery including an electrode assembly including a positive electrode, a separator, and a negative electrode; and an electrode tape attached to an outer surface of the electrode assembly.

The electrode tape includes a thermosetting resin. In one embodiment, the thermosetting resin may be selected from polyvinylchloride, a mixture of nitrile rubber and phenol resin, epoxy resin, polyurethane, melamine resin, urea resin, or a combination thereof. In another embodiment, the thermosetting resin may be a mixture of nitrile rubber and phenol resin, epoxy resin, polyurethane, and a combination thereof.

The electrode tape may further include an adhesive layer positioned on a surface contacting the electrode assembly.

The adhesive layer may further include an adhesive selected from one that is acrylate-based, urethane-based, melamine-based, epoxy-based, unsaturated ester-based, resorcinol-based, polyamide-based, vinyl-based, styrene-based, or a combination thereof. The adhesive layer which is positioned to contact the electrode assembly allows strong attachment of the electrode tape to the electrode assembly, so that the effect by using the electrode tape may be more improved.

The electrode tape may further include a metal. When the electrode tape further includes the metal, the electrode tape consists of a metal substrate and a thermosetting resin layer including the thermosetting resin surrounding the metal substrate. For example, the metal substrate can be positioned within the thermosetting resin layer.

The width of the metal substrate refers to vertical direction to longitudinal direction of the battery, and it is desirable that the width of the metal substrate is smaller than that of the positive electrode, and particularly, that it is 1 mm or more smaller than that of the positive electrode (e.g. if the width of the positive electrode is about 3 mm, that of the metal substrate is 2 mm m or less). If the width of the metal substrate is smaller than that of the positive electrode, alignment may be maintained, distortion of the electrode assembly may be prohibited, and the excellent safety may be maintained, when the electrode tape covers on the electrode assembly.

Furthermore, when the electrode tape further includes the metal, even if the battery is penetrated, the current path area through which current is passed is wide so that the safety may be improved. The metal may be aluminum. The aluminum metal is the same as that of a current collector of the positive electrode which is positioned at the outmost portion of the general electrode assembly, so that the battery resistance may be reduced.

The thickness of the thermosetting resin layer may be about 10 μm to about 2000 μm, and the thickness of the metal substrate may be about 1 μm to 1000 μm. Since the metal substrate is included in the thermosetting resin layer, the thickness of the metal substrate should not be larger than that of the thermosetting resin layer.

It is desirable to control the thickness of the metal substrate to less than that of the thermosetting resin layer in the above range. When the thickness of the thermosetting resin layer and the thickness of the metal substrate fall into the above ranges, the thickness of the battery is not increased so that decreases in the energy density, strength, and adhesion strength due to an increase in the thickness of the battery do not occur.

The electrode tape may have a length of about 100% to about 110% of that of the electrode assembly.

When the electrode tape length falls into the range, the thermosetting resin is sufficiently to cover all of the surface of the electrode assembly, thereby further improving the strength of the battery and further maintaining safety thief an the internal impact occurs.

The electrode tape including the metal substrate and the thermosetting resin layer covered on the metal substrate, and including the thermosetting resin, may also further include the adhesive layer positioned on the surface contacting the electrode assembly.

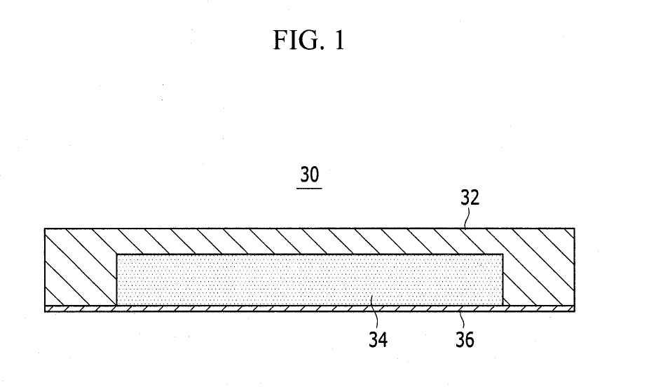

The structure of the electrode tape having the above structure is shown in FIG. 1. As shown in FIG. 1, the electrode tape 30 according to the present embodiments includes a metal substrate 34, a thermosetting resin layer 32 encompassing the surfaces of the metal substrate, and an adhesive layer 36 positioned on one surface of the thermosetting resin layer 32.

The electrode tape according to the present embodiments includes a thermosetting resin being capable of being melted by heat, and the thermosetting resin may be melted at about 90° C. to about 150° C., and the melted thermosetting resin allows adherence of the electrode assembly and the battery case. Furthermore, although the electrode assembly is not completely filled into the battery case, an empty inner space of the battery case may be filled with the thermosetting resin so that deformation of the battery rarely occurs.

Generally, a separator in the electrode assembly is positioned in the form of a protrusion since the length of the separator is larger than that of the electrode, but the electrode tape according to the present embodiments has the same length as that of the electrode assembly length or is about 110% of the length of the electrode assembly, so that the melted thermosetting resin may effectively cover the upper and lower parts of the separator, thereby suppressing the shrinkage of the protrusion parts of the separator in the transverse direction (TD) when the protrusion parts are exposed to the heat.

Furthermore, the melted thermosetting resin is hardened by removing heat, to cause sealing and strong bonding with the separators and to increase the strength by adhering the electrode assembly with the battery case, so that the strength and the hardness of the battery may be maintained.

According to one embodiment, the electrode assembly includes a positive electrode, a separator, and a negative electrode.

The positive electrode may include a current collector and a positive active material layer formed on the current collector.

The positive active material includes lithiated intercalation compounds that reversibly intercalate and deintercalate lithium ions. The positive active material may include a composite oxide including at least one selected from the group consisting of cobalt, manganese, and nickel, as well as lithium. Specific examples may be the compounds represented by the following chemical formulae.

LiₐA_{1-b}X_{b}D₂ (0.90≦a≦1.8, 0≦b≦0.5); LiₐA_{1-b}X_{b}O_{2-c}D_{c} (0.90≦a≦1.8, 0≦b≦0.5, 0≦c≦0.05); LiₐE_{1-b}X_{b}O_{2-c}D_{c} (0≦b≦0.5, 0≦c≦0.05); LiₐE_{2-b}X_{b}O_{4-c}D_{c} (0≦b≦0.5, 0≦c≦0.05); LiₐNi_{1-b-c}Co_{b}X_{c}D_{α} (0.90≦a≦1.8, 0≦b≦0.5, 0≦c≦0.5, 0<α≦2); LiₐNi_{1-b-c}Co_{b}X_{c}O_{2-α}T_{α} (0.90≦a≦1.8, 0≦b≦0.5, 0≦c≦0.05, 0<α<2); LiₐNi_{1-b-c}Co_{b}X_{c}O_{2-α}T₂ (0.90≦a≦1.8, 0≦b≦0.5, 0≦c≦0.05, 0<α<2); LiₐNi_{1-b-c}Mn_{b}X_{c}D_{α} (0.90≦a≦1.8, 0≦b≦0.5, 0≦c≦0.05, 0<α≦2); LiₐNi_{1-b-c}Mn_{b}X_{c}O₂₋ₐT_{α} (0.90≦a≦1.8, 0≦b≦0.5, 0≦c≦0.05, 0<α<2); LiₐNi_{1-b-c}Mn_{b}X_{c}O_{2-α}T₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GₑO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1) LiₐCoG_{b}O₂ (0.90≦a≦1.8, 0.001≦b≦0.1); LiₐMn_{1-b}G_{b}O₂ (0.90≦a≦1.8, 0.001≦b≦0.1); LiₐMn₂G_{b}O₄ (0.90≦a≦1.8, 0.001≦b≦0.1); LiₐMn_{1-g}G_{g}PO₄ (0.90≦a≦1.8, 0≦g≦0.5); QO₂; QS₂; LiQS₂; V₂O₅; LiV₂O₅; LiZO₂; LiNiVO₄; Li_{(3-f)}J₂PO₄₃ (0≦f≦2); Li_{(3-f)}Fe₂PO₄₃ (0≦f≦2); LiₐFePO₄ (0.90≦a≦1.8)

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

The positive active material may be a compound with the coating layer on the surface or a mixture of the active material and a compound with the coating layer thereon.

The coating layer may include at least one coating element compound selected from the group consisting of an oxide of the coating element, a hydroxide of the coating element, an oxyhydroxide of the coating element, an oxycarbonate of the coating element, and a hydroxycarbonate of the coating element.

The compound for the coating layer may be either amorphous or crystalline. The coating element included in the coating layer may be Mg, Al, Co, K, Na, Ca, Si, Ti, V, Sn, Ge, Ga, B, As, Zr, or a mixture thereof.

The coating process may include any conventional process unless it causes any side effects on the properties of the positive active material (e.g., spray coating, immersing), which is well known to those who have ordinary skill in this art and will not be illustrated in detail.

In the positive active material layer, the amount of the positive active material may be about 90 wt % to about 98 wt % based on the total weight of the positive active material layer.

The positive active material layer includes a binder and a conductive material. The binder and the conductive material may be included in an amount of about 1 wt % to about 5 wt %, respectively, based on the total weight of the positive active material layer.

The binder improves binding properties of the positive active material particles to one another and to a current collector. Examples of the binder include polyvinyl alcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but is not limited thereto.

The conductive material improves electrical conductivity of a negative electrode. Any electrically conductive material can be used as a conductive agent unless it causes a chemical change. Examples of the conductive material include natural graphite, artificial graphite, carbon black, acetylene black, ketjen black, a carbon fiber, a metal powder or a metal fiber including copper, nickel, aluminum, silver, and the like. A conductive material such as a polyphenylene derivative and the like may be mixed.

The current collector may be Al but is not limited thereto.

The negative electrode includes a current collector and a negative active material layer formed on the current collector. The negative active material layer includes a negative active material.

The negative active material layer includes a negative active material. The negative active material includes a material that reversibly intercalates/deintercalates lithium ions, a lithium metal, a lithium metal alloy, a material being capable of doping and dedoping lithium, or a transition metal oxide.

The material that can reversibly intercalate/deintercalate lithium ions includes a carbon material.

The carbon material may be any carbon-based negative active material generally used in a lithium ion rechargeable battery. Examples of the carbon material include crystalline carbon, amorphous carbon, and mixtures thereof. The crystalline carbon may be non-shaped, or sheet, flake, spherical, or fiber-shaped natural graphite or artificial graphite. The amorphous carbon may be a soft carbon, a hard carbon, a mesophase pitch carbonized product, fired coke, and the like.

Examples of the lithium metal alloy include lithium and a metal of Na, K, Rb, Cs, Fr, Be, Mg, Ca, Sr, Si, Sb, Pb, In, Zn, Ba, Ra, Ge, Al, or Sn. The material being capable of doping and dedoping lithium may include Si, a composite of Si—C, SiOₓ (0<x<2), a Si-Q alloy (wherein Q is an element selected from an alkali metal, an alkaline-earth metal, group 13 to 16 elements, a transition element, a rare earth element, or a combination thereof, and is not Si), Sn, SnO₂, a Sn—R alloy (wherein R is an element selected from an alkali metal, an alkaline-earth metal, group 13 to 16 elements, a transition element, a rare earth element, or a combination thereof, and is not Sn), and the like. At least one of these may be used as a mixture with SiO₂.

The elements Q and R may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof. The transition metal oxide may include vanadium oxide, lithium vanadium oxide, and the like.

In the negative active material layer, the amount of the negative active material may be about 95 wt % to about 99 wt % based on the total weight of the negative active material layer.

The negative active material layer also includes a binder and optionally a conductive material. In the negative active material layer, the binder may be included in an amount of about 1 wt % to about 5 wt % based on the total weight of the negative active material layer.

When the negative active material layer includes a conductive material, the negative active material layer includes about 90 wt % to about 98 wt % of the negative active material, about 1 wt % to about 5 wt % of the binder, and about 1 wt % to about 5 wt % of the conductive material.

The binder improves binding properties of negative active material particles with one another and with a current collector. The binder may be a non-water-soluble binder, a water-soluble binder, or a combination thereof. The non-water-soluble binder includes polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, polyamideimide, polyimide, or a combination thereof.

The aqueous binder refers to use of water as a solvent or a dispersing agent. The aqueous binder includes rubber-based binders or polymer resin binders.

The rubber-based binder may be styrene-butadiene rubber, acrylated styrene-butadiene rubber, acrylonitrile-butadiene rubber, acryl rubber, butyl rubber, fluorine rubber, and a combination thereof. The polymer resin binder may be polyethylene, polypropylene, a copolymer of ethylene and propylene, polyethylene oxide, polyepichlorohydrine, polyphosphazene, polyacrylonitrile, polystyrene, an ethylene-propylene-diene copolymer, polyvinyl pyrridine, chloro sulfonated polyethylene, latex, polyester resin, acryl resin, phenol resin, epoxy resin, polyvinyl alcohol, sodium polyacrylacrylic acid, a copolymer of propylene and a C₂ to C₈ olefin, and a copolymer of (meth)acrylic acid and (meth)acrylic acid alkyl ester. When the water-soluble binder is used as a negative electrode binder, a cellulose-based compound may be further used to provide viscosity as a thickener.

The cellulose-based compound includes one or more of carboxylmethyl cellulose, hydroxypropylmethyl cellulose, methyl cellulose, or alkali metal salts thereof. The alkali metal may be Na, K, or Li. The cellulose-based compound may be included in an amount of about 0.1 to about 3 parts by weight based on 100 parts by weight of the negative active material.

The conductive material is included to improve electrode conductivity. Any electrically conductive material may be used as a conductive material unless it causes a chemical change. Examples of the conductive material include a carbon-based material such as natural graphite, artificial graphite, carbon black, acetylene black, ketjen black, a carbon fiber, and the like; a metal-based material of a metal powder or metal fiber including copper, nickel, aluminum, silver, and the like; conductive polymers such as polyphenylene derivatives; or a mixture thereof.

The current collector may be selected from a copper foil, a nickel foil, a stainless steel foil, a titanium foil, a nickel foam, a copper foam, a polymer substrate coated with a conductive metal, and a combination thereof.

The negative and positive electrodes may be respectively prepared by mixing the active material, the conductive material, and the binder in a solvent to prepare an active material composition and coating the composition on the current collector. The electrode manufacturing method is well known, and thus is not described in detail in the present specification.

The solvent may be N-methyl pyrrolidone, but it is not limited thereto. If the negative electrode uses the aqueous binder, the solvent for preparing the negative active material composition may be water.

The rechargeable lithium battery further includes an electrolyte. The electrolyte includes an organic solvent and a lithium salt.

The organic solvent serves as a medium for transmitting ions taking part in the electrochemical reaction of the battery. The organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include methyl acetate, ethyl acetate, n-propyl acetate, dimethyl acetate, methylpropionate, ethylpropionate, γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, and the like, and the ketone-based solvent may include cyclohexanone and the like. The alcohol-based solvent include ethyl alcohol, isopropyl alcohol, and the like, and examples of the aprotic solvent include nitriles such as R—CN (where R is a C₂ to C₂₀ linear, branched, or cyclic hydrocarbon that may include a double bond, an aromatic ring, or an ether bond), amides such as dimethylformamide, dioxolanes such as 1,3-dioxolane, sulfolanes, and the like. The organic solvent may be used singularly or in a mixture.

When the organic solvent is used in a mixture, the mixture ratio can be controlled in accordance with a desirable battery performance.

The carbonate-based solvent may include a mixture with a cyclic carbonate and a linear carbonate. The cyclic carbonate and the linear carbonate are mixed together in a volume ratio of about 1:1 to about 1:9. When the mixture is used as an electrolyte, it may have enhanced performance.

In addition, the non-aqueous organic electrolyte may further include an aromatic hydrocarbon-based solvent as well as the carbonate-based solvent. The carbonate-based solvent and the aromatic hydrocarbon-based solvent may be mixed together in a volume ratio of about 1:1 to about 30:1. The aromatic hydrocarbon-based organic solvent may be represented by the following Chemical Formula 1.

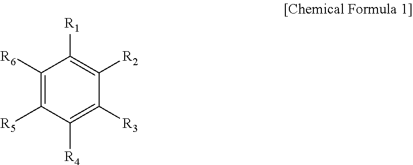

In Chemical Formula 1, R₁ to R₆ are the same or different and are selected from hydrogen, a halogen, a C1 to C10 alkyl group, a haloalkyl group, and a combination thereof. The aromatic hydrocarbon-based organic solvent may include one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate or an ethylene carbonate-based compound represented by the following Chemical Formula 2 to improve cycle life.

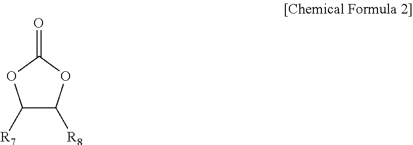

In Chemical Formula 2, R₇ and R₈ are independently hydrogen, a halogen, a cyano (CN) group, a nitro (NO2) group, or a C1 to C5 fluoroalkyl group, provided that at least one of R₇ and R₈ is a halogen, a nitro (NO₂) group, or a C1 to C5 fluoroalkyl group, and R₇ and R₈ are not simultaneously hydrogen.

The ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the additive for improving cycle life may be flexibly used within an appropriate range.

The lithium salt is dissolved in an organic solvent, supplies a battery with lithium ions, basically operates the rechargeable lithium battery, and improves transportation of the lithium ions between positive and negative electrodes.

Such a lithium salt may include at least one supporting salt selected from LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (where x and y are natural numbers), LiCl, LiI, and LiB(C₂O₄)₂ (lithium bis(oxalato) borate; LiBOB).

The lithium salt may be used in a concentration ranging from about 0.1 M to about 2.0 M. When the lithium salt is included at the above concentration range, an electrolyte may have optimal electrolyte conductivity and viscosity, and may thus have enhanced performance and effective lithium ion mobility.

The separator may include polyethylene, polypropylene, and polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The rechargeable lithium battery according to one embodiment may have any structures such as cylindrical, prismatic, coin-type, and pouch.

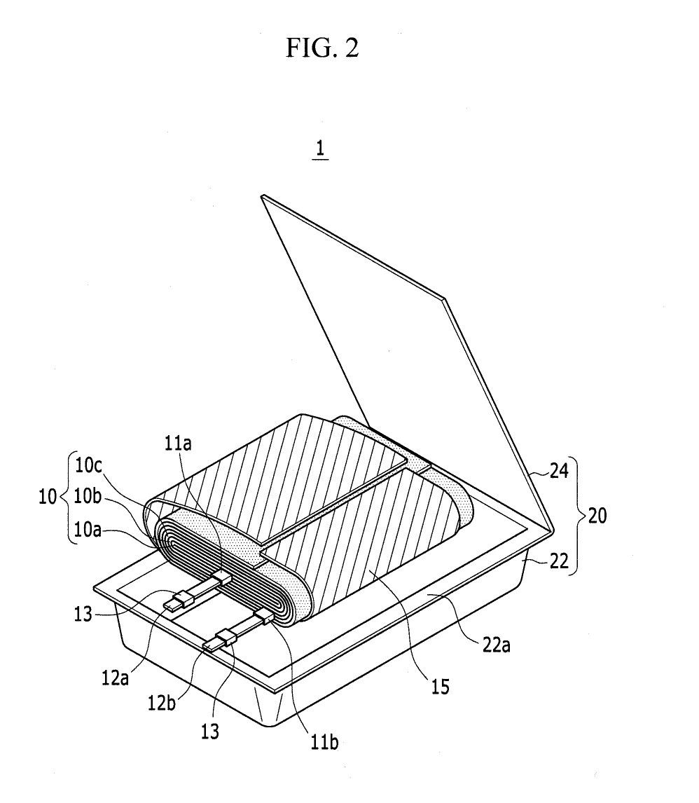

As one example, a rechargeable lithium battery in the form of a pouch is shown in FIG. 2. In FIG. 2, the electrode tape 15 is illustrated to be shorter than the electrode assembly 10 in order to show the structure of the electrode assembly 10, but the electrode tape 15 has substantially 100% to 110% of the length based on the length of the electrode assembly 10, as described above.

The rechargeable lithium battery 1 according to one embodiment includes an electrode assembly 10 and an electrode tape 15 surrounding and adhered to the outer surface of the electrode assembly 10, as shown in FIG. 2.

The electrode tape 15 refers to an electrode tape according to one embodiment, and may be positioned to particularly adhere to both ends of the positive electrode in the electrode assembly as shown in FIG. 2.

When the electrode tape is adhered to both ends, the electrode tape simultaneously acts as an end tape, so the battery fabrication process may be further simplified. The electrode assembly 10 according to one embodiment includes a first electrode (10a, positive electrode or negative electrode), a second electrode (10b, opposite electrode to the first electrode, e.g., if the first electrode is a positive electrode, the second electrode is a negative electrode), and a separator 10c between the first electrode 10a and the second electrode 10b.

Furthermore, a first electrode tab 12a is bonded to the first electrode 10a to protrude to the upper part of the electrode assembly 10 and a second electrode tab 12b is bonded to the second electrode 10b to protrude to the upper of the electrode assembly 10. The first electrode tab 12a and the second electrode tab 12b are separately positioned at a predetermined distance and electrically insulated from each other.

The portions of the first electrode tab 12a and the second electrode tab 12b protruding from the electrode assembly 10 are respectively covered with lamination tapes 11a and 11b which intercept heat generated at the first electrode tab 12a and the second electrode tab 12b, and inhibit pressing of the side of the first electrode tab 12a or the second electrode tab 12b to the electrode assembly 10.

Furthermore, an insulating tape 13 is adhered to the surface at which the first electrode tab 12a and the second electrode tab 12b contact the battery case 20, and it is partially protruded to the outer part of the battery case 20. If a cover part 24 of the battery case 20 is folded into the upper part of a receiving part 22 and sealed, the insulating tape 13 is positioned between the cover part 24 and the receiving part 22 and at the area on which the first electrode tab 12a and the second electrode tab 12b are positioned.

The following examples illustrate the embodiments in more detail. These examples, however, are not in any sense to be interpreted as limiting the scope of the embodiments.

### Example 1

A polyurethane thermosetting resin was coated on an aluminum substrate with a thickness of about 3 μm to 100 μm, to have a thickness of about 5 μm to 150 μm, thereby surrounding the surface of the aluminum substrate with the thermosetting resin.

A thermosetting resin layer including the aluminum substrate therein was prepared. Thereafter, an acrylate-based binder was coated on one surface of the thermosetting resin layer to form an adhesive layer, thereby obtaining an electrode tape.

A LiCoO₂ positive electrode, a polyethylene/polypropylene separator and a graphite negative electrode were sequentially layered and spirally-wounded to prepare a jelly-roll type of electrode assembly.

The electrode tape was wrapped around the outer surface of the electrode assembly, which was then placed in the battery case, and an electrolyte solution was injected into, thereby fabricating a rechargeable lithium battery.

As the electrolyte solution, a 1.0 M LiPF₆ dissolved in a mixed solvent of ethylene carbonate, methyl ethyl carbonate, and dimethyl carbonate (3:4:4 volume ratio) was used.

The fabricated rechargeable lithium rechargeable battery exhibits excellent safety.

While the embodiments have been described in connection with what is presently considered to be practical example embodiments, it is to be understood that the embodiments are not limited to the disclosed embodiments, but, on the contrary, is intended to cover various modifications and equivalent arrangements included within the spirit and scope of the appended claims.

What is claimed is:

1. A rechargeable lithium battery comprising:
an electrode assembly comprising a positive electrode, a separator, and a negative electrode; and
an electrode tape adhered to an outer surface of the electrode assembly,
wherein the electrode tape comprises a thermosetting resin comprising at least one of polyvinylchloride, a mixture of nitrile rubber and phenol resin, epoxy resin, polyurethane, melamine resin, and urea resin.

2. The rechargeable lithium battery of claim 1, wherein the thermosetting resin comprises at least one of a mixture of nitrile rubber and phenol resin, epoxy resin, and polyurethane.

3. The rechargeable lithium battery of claim 1, wherein the thermosetting resin is polyurethane.

4. The rechargeable lithium battery of claim 1, wherein the electrode tape includes a metal.

5. The rechargeable lithium battery of claim 4, wherein the metal is aluminum.

6. The rechargeable lithium battery of claim 1, wherein the electrode tape further includes an adhesive layer positioned on a surface to contact the electrode assembly.

7. The rechargeable lithium battery of claim 1, wherein the electrode tape includes a metal substrate and a thermosetting resin layer surrounding the metal substrate.

8. The rechargeable lithium battery of claim 1, wherein the thermosetting resin layer has a thickness of about 10 μm to about 2000 μm.

9. The rechargeable lithium battery of claim 7, wherein the metal substrate has a thickness of about 1 μm to about 1000 μm.

10. The rechargeable lithium battery of claim 1, wherein the electrode tape has a length of about 100% to about 110% of the length of the electrode assembly.

11. A method of strengthening a rechargeable battery comprising:
wrapping an election tape around the outer surface of an electrode assembly of the rechargeable battery,
wherein the electrode tape comprises a thermosetting resin comprising at least one of polyvinylchloride, a mixture of nitrile rubber and phenol resin, epoxy resin, polyurethane, melamine resin, and urea resin.

12. The method of claim 11, wherein the thermosetting resin comprises at least one of a mixture of nitrile rubber and phenol resin, epoxy resin, and polyurethane.

13. The method of claim 11, wherein the thermosetting resin is polyurethane.

14. The method of claim 11, wherein the electrode tape includes a metal.

15. The method of claim 14, wherein the metal is aluminum.

16. The method of claim 11, wherein the electrode tape further includes an adhesive layer positioned on a surface to contact the electrode assembly.

17. The method of claim 11, wherein the electrode tape includes a metal substrate and a thermosetting resin layer surrounding the metal substrate.

18. The method of claim 11, wherein the thermosetting resin layer has a thickness of about 10 μm to about 2000 μm.

19. The method of claim 17, wherein the metal substrate has a thickness of about 1 μm to about 1000 μm.

20. The method of claim 11, wherein the electrode tape has a length of about 100% to about 110% of the length of the electrode assembly.
